(19) United States
(12) Patent Application Publication
(10) Pub. No.: US 2016/0268638 A1
(43) Pub. Date: Sep. 15, 2016

(54) METHOD OF MANUFACTURING ALL-SOLID BATTERY THROUGH WET-DRY MIXING PROCESS

(71) Applicant: Hyundai Motor Company, Seoul (KR)

(72) Inventors: Yong Jun Jang, Seongnam (KR); Ho Taek Lee, Seoul (KR); Eun Ji Kwon, Gunpo (KR); Ju Young Sung, Suwon (KR); Ji Na Kim, Anyang (KR)

(21) Appl. No.: 14/966,555

(22) Filed: Dec. 11, 2015

(30) Foreign Application Priority Data
Mar. 12, 2015 (KR) 10-2015-0034351

(51) Int. Cl. H01M 10/0585; H01M 10/0562

(52) U.S. Cl. CPC H01M 10/0585; H01M 10/0562; H01M 2300/0068

(57) ABSTRACT

Disclosed is a method of manufacturing an all-solid battery by a wet-dry mixing process, such that a binder can be uniformly dispersed in a solid electrolyte layer. As such, the size of the battery can be increased and and a thickness of the battery can be reduced.

### CROSS-REFERENCE TO RELATED APPLICATION

This application claims under 35 U.S.C. §119(a) the benefit of Korean Patent Application No. 10-2015-0034351 filed on Mar. 12, 2015, the entire contents of which are incorporated herein by reference.

### TECHNICAL FIELD

The present invention relates to a method of manufacturing an all-solid battery by a wet-dry mixing process. Particularly, the method includes preparing a solid electrolyte slurry by the wet-dry mixing process such that a binder may be uniformly dispersed in a solid electrolyte layer. Thus, the all-solid battery can be manufactured in greater size, while a thickness of the battery can be reduced.

### BACKGROUND

Recently, a rechargeable secondary battery has been extensively used as a large-capacity electric power storage battery for an electric vehicle, an electric power storage system, and the like, and as a small-sized high performance energy source for a mobile electronic apparatus such as a mobile phone, a camcorder, and a notebook computer.

A lithium ion battery as the secondary battery has advantages, such as convenient use, since a capacity per unit area is improved, a self discharge ratio is reduced, and there is no memory effect, as compared to a nickel-manganese battery or a nickel-cadmium battery.

The lithium ion battery includes a carbon-based cathode, an electrolyte containing an organic solvent, and a lithium oxide anode. Due to a chemical reaction occurring at the anode and the cathode, a lithium ion is emitted from the anode and transported through the electrolyte to the carbon-based cathode during charging, and a discharging process is a reverse process of the charging. That is, the lithium ion battery is a representative secondary battery where charging and discharging may be performed repeatedly as the lithium ion passes between the anode and the cathode.

However, since the lithium ion battery uses a liquid electrolyte containing an organic solvent, there are various problems, such as instability of the battery due to leakage of highly volatile organic solvent, impact, and the like.

Therefore, in order to secure safety of the lithium ion battery, research of an all-solid battery using a solid electrolyte instead of the liquid electrolyte has been actively performed.

The all-solid battery using the solid electrolyte may provide various advantages. For example, ignition occurring in the liquid electrolyte can be prevented, and volume energy density may be improved as the all-solid battery is manufactured to have a bipolar structure.

In the related arts, a conventional all-solid battery has been manufactured by a dry process, which includes laminating each a solid electrolyte powder, a cathode active material powder, and an anode active material powder. The dry process for manufacturing the all-solid battery may be very simplified, but the dry process by pressing the powders may not perform enlargement of the all-solid battery.

Korean Patent Application Laid-Open No. 10-2013-0130820 has disclosed a method of manufacturing a secondary battery, including applying a slurry including a solvent, a binder, and a solid electrolyte on a base material to manufacture a solid electrolyte sheet and applying a slurry including an electrode active material on a substrate to form an electrode. However, since in the method, the slurry including the solid electrolyte is applied on the base material, it is difficult to manufacture the battery in a thin film. Further, since the method performed only with a wet process, the process may be complicated, and contact between the solid electrolyte and the electrode may not be uniformly maintained, and thus performance of a battery, such as a battery capacity, may not be sufficient.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention provides a thin film of an all-solid battery by manufacturing an all-solid battery by combining a wet process and a dry process. As such, the all-solid battery can be increased in size.

The object of the present invention is not limited to the aforementioned matter, and unmentioned other objects may be clearly understood by the person with ordinary skill in the art from the following description.

In one aspect, the present invention provides a method of manufacturing an all-solid battery by a wet-dry mixing process. The method may comprise: preparing a solid electrolyte slurry by mixing a solvent, a binder, and a solid electrolyte; preparing a solid electrolyte mixture powder by drying the solid electrolyte slurry to remove the solvent r; forming a thin film solid electrolyte layer by compressing the solid electrolyte mixture powder; applying a cathode active material and an anode active material on the thin film solid electrolyte layer; and applying a pressure on the cathode active material and anode active material. Alternatively, the method may comprise: preparing a solid electrolyte slurry by mixing a solvent, a binder, and a solid electrolyte; preparing a solid electrolyte mixture powder by drying the solid electrolyte slurry to remove the solvent; forming a thin film solid electrolyte layer by compressing the solid electrolyte mixture powder; and laminating a cathode active material and an anode active material on each surface of the thin film solid electrolyte layer.

The term “solid electrolyte”, as used herein, refers to a solid phase material (e.g. ceramic, crystalline, polymer, ionic compound, organic compound and the like) that can provide electric conductivity or ionic conductivity. In the solid electrolyte, electrons or ions can move or be transferred without a need of fluid or a liquid, as compared to “non-solid electrolyte” material. Preferably, the solid electrolyte may be a ceramic solid electrolyte.

The term “thin film”, as used herein, refers to a layered material suitably have a thickness of about 1 μm to about 1 mm, of about 10 μm to 500 μm or particularly of about 20 μm to 100 μm. The thin film may also be formed in a single layer or in multiple layers. The thickness of the thin film may be uniform or non-uniform without limitations to portions thereof, however, the thickness thereof may be substantially reduced to micrometer scale as compared to “non-thin film”.

In a preferred embodiment, the solid electrolyte slurry may include an amount of about 40 to 70 wt % of the solid electrolyte, an amount of about 1 to 10 wt % of the binder, and an amount of about 20 to 50 wt % of the solvent, all the wt % based on the total weight of the solid electrolyte slurry.

In a preferred embodiment, when preparing the solid electrolyte mixture powder, the solid electrolyte slurry may be dried under a vacuum state.

In a preferred embodiment, the cathode active material and the anode active material may be applied on each surface of the thin film solid electrolyte layer such that the thin film solid electrolyte layer may be interposed between the cathode active material and the anode active material. Further, the pressure may be applied to the cathode active material and the anode active material by using a current collector substrate.

Preferably, the solid electrolyte may comprise at least one selected from the group consisting of Li₂S—P₂S₅, Li₆PS₅Cl, and Li₁₀SnP₂S₁₂.

Preferably, the solvent may comprise at least one selected from the group consisting of xylene, hexane, and benzene.

Preferably, the binder may comprise at least one selected from the group consisting of an acrylonitrile butadiene rubber (NBR), an acryl polymer, and a silicon polymer.

Preferably, the cathode active material may be LiCoO₂. The anode active material may be a graphite.

The present invention may provide the following advantages.

Since the all-solid battery is manufactured by combined processes of a wet process and a dry process, a binder may be uniformly dispersed in a solid electrolyte layer, and thus the method may be useful for enlarging the battery and reducing a thickness of the battery.

In particular, the thin film solid electrolyte layer may be manufactured by only a solid electrolyte slurry without a base material, a substrate, or the like, the thickness thereof can be reduced substantially.

Further provided is an all-solid battery manufactured by the methods as described herein. In particular, the solid electrolyte layer may be formed in a thin film such that the size of the battery may be increased and the weight thereof may be reduced.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 illustrates an exemplary method of manufacturing an all-solid battery by a wet-dry mixing process according to an exemplary embodiment of the present invention;

FIG. 2 is a graph which shows an energy capacity of an all-solid battery manufactured by a Comparative Example; and

FIG. 3 is a graph which shows an energy capacity of an exemplary all-solid battery manufactured by Example 1.

Reference numerals set forth in the Drawings include reference to the following elements as further discussed below:

| | |
|---|---|
| 10: solid electrolyte slurry | |
| 30: solid electrolyte layer | |
| 50: cathode active material | 51: anode |
| 70: anode active material | 71: cathode |
| 90: current collector substrate | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described in more detail below.

A method of manufacturing an all-solid battery through a wet-dry mixing process. The method may include: (1) preparing a solid electrolyte slurry 10 by mixing a solvent, a binder, and a solid electrolyte; (2) preparing a solid electrolyte mixture powder by drying the solid electrolyte slurry 10 and removing the solvent and thus manufacture; (3) forming a thin film solid electrolyte layer 30 by compressing the solid electrolyte mixture powder to manufacture; (4) applying a cathode active material 50 and an anode active material 70 on the solid electrolyte layer 30; and (5) applying a pressure on the cathode active material and the anode active material.

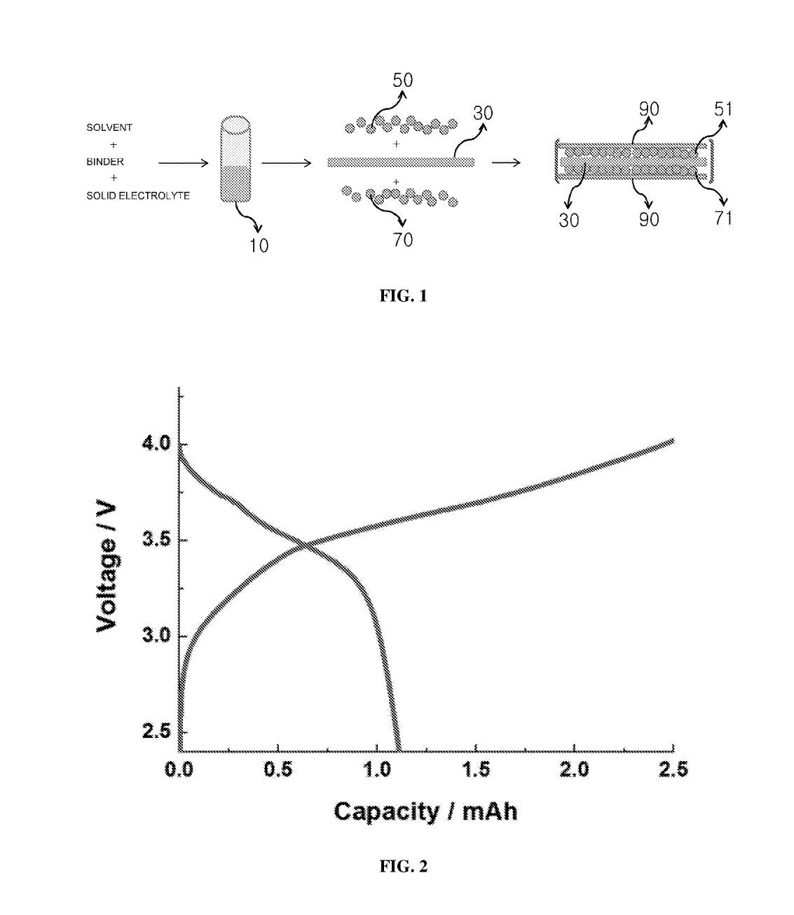

As shown in FIG. 1, an exemplary all-solid battery manufactured according to an exemplary embodiment of the present invention may have a structure formed by laminating a cathode 71, the solid electrolyte layer 30, and an anode 51. In particular, the solid electrolyte layer may be manufactured by using the solid electrolyte slurry, unlike the solid electrolyte layer manufactured by a dry process, and further, a binder may be included.

When each constituent element thereof is maintained in a stable structure in an entire area of the battery and endures an impact from the outside, performance of the battery may be maintained and enlargement may be achieved.

According to an exemplary embodiment of the present invention, the binder may increase combination force between the constituent elements of the solid electrolyte layer and may absorb an external impact, such that the binder may be an essential factor in enlargement of the battery.

However, in the conventional method to manufacture the solid electrolyte layer using a dry process by adding the binder to the solid electrolyte, the solid electrolyte and the binder may not be sufficiently mixed by mechanical means, such that the binder may not be uniformly dispersed in the solid electrolyte layer due to intrinsic characteristic of the binder, and thus it may be difficult to enlarge the battery.

On the other hand, according to the present invention, the solid electrolyte and the binder may be added to the solvent by a wet process, and a sufficient agitation process may be performed for mixing the solid electrolyte and the binder. As such, the binder and the solid electrolyte may be uniformly mixed to prepare the solid electrolyte layer where the binder is uniformly distributed, and thus enlarging the battery may be obtained.

The solid electrolyte mixture powder, as used herein, means a powder which includes the solid electrolyte remaining after the solvent is removed from the solid electrolyte slurry by drying, and the binder. Since the solvent is removed after sufficient agitation is performed in the solid electrolyte slurry for the solid electrolyte to be uniformly dispersed in the solvent, unlike the conventional dry process (simple mixing), the solid electrolyte layer where the solid electrolyte and the binder may be uniformly mixed may be manufactured.

The solvent may be preferably removed through vacuum drying. In a natural drying method, a drying speed may be delayed, and in a heating drying method a side reaction may occur. Accordingly, in the present invention, the solvent may be effectively removed without generation of an impurity by using a vacuum drying method.

Further, since the binder is included in the solid electrolyte mixture powder, the thin film solid electrolyte layer may be manufactured by including only the solid electrolyte mixture powder. Since the structure of the solid electrolyte layer may be stably maintained in a wide entire area of the enlarged battery by the binder, a separate base material or film and the like may not be required to fix the solid electrolyte powder. As such, according to the exemplary embodiments of the present invention, the thin film solid electrolyte layer can be manufactured.

Preferably, the solid electrolyte may comprise at least one selected from the group consisting of Li₂S—P₂S₅, Li₆PS₅Cl, and Li₁₀SnP₂S₁₂, and the solid electrolyte may be included in a content of about 40 to 70 wt % based on the total weight of the solid electrolyte slurry.

Preferably, the binder may comprise at least one selected from the group consisting of an acrylonitrile butadiene rubber (NBR), an acryl polymer, and a silicon polymer, and the binder may be included in a content of about 1 to 10 wt % based on the total weight of the solid electrolyte slurry.

Further, preferably, the solvent may comprise at least one selected from the group consisting of xylene, hexane, and benzene, and the solvent may be included in a content of about 20 to 50 wt % based on the total weight of the solid electrolyte slurry.

As discussed above, when the solid electrolyte, the binder, and the solvent are used in the aforementioned range, the solid electrolyte, the binder, and the solvent may be uniformly dispersed in the solid electrolyte slurry, and the solid electrolyte layer manufactured by using the same can be used in the battery.

### EXAMPLES

The following examples illustrate the invention and are not intended to limit the same.

Hereinafter, the present invention will be described in more detail through the Examples. However, the Examples are set forth to illustrate the present invention, but the scope of the present invention is not limited thereto.

### Example 1

### Manufacturing of all-Solid Large-Sized Thin Film Battery

The Li₂S—P₂S₅ (LSPS) powder as the solid electrolyte was added into a solvent, i.e. xylene, and uniformly dispersed by using the mixer. Subsequently, the acrylonitrile butadiene rubber (NBR) that was the binder was put and re-dispersed by using the mixer again to manufacture the solid electrolyte slurry 10.

(2) The solid electrolyte slurry 10 was dried under the vacuum at a temperature of 80° to remove xylene.

(3) The pressure was applied to the solid electrolyte mixture powder from which the solvent was removed by using the press jig to manufacture the thin film solid electrolyte layer 30 having the size of 60×80 mm².

(4) After LiCoO₂ as the cathode active material 50 and the artificial graphite as the anode active material 70 were applied in the powder state on the thin film sheet, the pressure was applied by using the current collector substrate 90 to manufacture the all-solid battery cell having the structure where the anode 51, the solid electrolyte layer 30, and the cathode 71 are laminated.

### Example 2

### Measurement of Energy Capacity of all-Solid Large-Sized Thin Film Battery

The energy capacity of the all-solid battery manufactured by Example 1 was measured.

As a Comparative Example, like in the related art, the all-solid battery manufactured by the dry process was used, and for example, materials of the used solid electrolyte, binder, cathode active material, and anode active material were configured to be the same as those of Example 1.

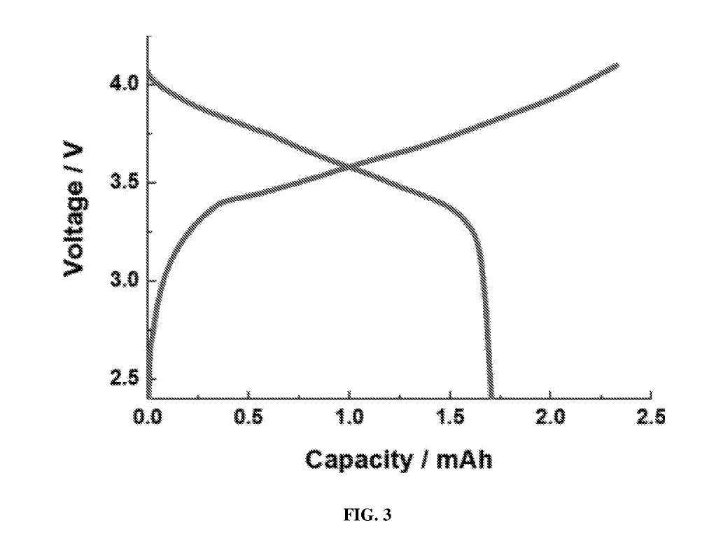

FIG. 2 is a graph obtained by measuring the energy capacity of the all-solid battery manufactured by the Comparative Example, and FIG. 3 is a graph obtained by measuring the energy capacity of an exemplary all-solid battery manufactured by Example 1.

As comparing FIGS. 2 and 3, it can be confirmed that the energy capacity of the all-solid battery manufactured by Example 1 is improved compared to the conventional all-solid battery manufactured by the Comparative Example.

In the Comparative Example and Example 1, the all-solid batteries having the same size were manufactured, and from the low energy capacity of the all-solid battery of the Comparative Example, the size of the battery may not be sufficiently enlarged by the conventional dry process.

The present invention provides the method of manufacturing the all-solid battery through the wet-dry mixing process, and further provides advantages that performance of the all-solid battery may be maintained and improved, the size of the battery and the thickness of the battery may be reduced.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method of manufacturing an all-solid battery through a wet-dry mixing process, comprising:
preparing a solid electrolyte slurry by mixing a solvent, a binder, and a solid electrolyte;
preparing a solid electrolyte mixture powder by drying the solid electrolyte slurry to remove the solvent;
forming a thin film solid electrolyte layer by compressing the solid electrolyte mixture powder;
applying a cathode active material and an anode active material on o each surface of the thin film solid electrolyte layer; and
applying a pressure on the cathode active material and anode active material.

2. The method of claim 1, wherein the solid electrolyte slurry comprises an amount of about 40 to 70 wt % of the solid electrolyte, an amount of about 1 to 10 wt % of the binder, and an amount of about 20 to 50 wt % of the solvent, all the wt % based on the total weight of the solid electrolyte slurry.

3. The method of claim 1, wherein the solid electrolyte slurry is dried under a vacuum state.

4. The method of claim 1, wherein the cathode active material and the anode active material are applied on each surface of the thin film solid electrolyte layer such that the thin film solid electrolyte layer is interposed between the cathode active material and the anode active material.

5. The method of claim 1, wherein the pressure is applied to the cathode active material and the anode active material by using a current collector substrate.

6. The method of claim 1, wherein the solid electrolyte comprises at least one selected from the group consisting of Li₂S—P₂S₅, Li₆PS₅Cl, and Li₁₀SnP₂S₁₂.

7. The method of claim 1, wherein the solvent comprises at least one selected from the group consisting of xylene, hexane, and benzene.

8. The method of claim 1, wherein the binder comprises at least one selected from the group consisting of an acrylonitrile butadiene rubber (NBR), an acryl polymer, and a silicon polymer.

9. The method of claim 1, wherein the cathode active material is LiCoO₂.

10. The method of claim 1, wherein the anode active material is a graphite.

11. A method of manufacturing an all-solid battery through a wet-dry mixing process, comprising:
preparing a solid electrolyte slurry by mixing a solvent, a binder, and a solid electrolyte;
preparing a solid electrolyte mixture powder by drying the solid electrolyte slurry to remove the solvent;
forming a thin film solid electrolyte layer by compressing the solid electrolyte mixture powder; and
laminating a cathode active material and an anode active material on each surface of the thin film solid electrolyte layer.

12. An all-solid battery that is manufactured by a method of claim 1.
